(19) United States
(12) Patent Application Publication
(10) Pub. No.: US 2015/0266426 A1
(43) Pub. Date: Sep. 24, 2015

(54) DETACHABLE VEHICLE MIRROR

(71) Applicant: Doug Woiden, Watrous (CA)

(72) Inventor: Doug Woiden, Watrous (CA)

(21) Appl. No.: 14/221,730

(22) Filed: Mar. 21, 2014

(51) Int. Cl. B60R 1/078

(52) U.S. Cl. CPC B60R 1/078

(57) ABSTRACT

A reflective surface device that is detachably mountable to the exterior of a vehicle and method of making and using the same is provided. The reflective surface device has an arm having a proximal end and a distal end, a reflective surface disposed adjacent the distal end of the arm, and a magnet disposed adjacent the proximal end of the arm. In a method of using the reflective surface device, a user positions the magnet on an exterior surface of the vehicle with the reflective surface facing generally rearward of the vehicle, whereby magnetic forces between the magnet and the exterior surface of the vehicle support the reflective surface device on the vehicle. To detach the reflective surface device from the vehicle, the user applies a force to overcome the magnetic forces between the magnet and the exterior surface of the vehicle.

### FIELD OF THE INVENTION

This invention is in the field of exterior vehicle mirrors, and more specifically to such mirrors that are detachable from a vehicle.

### BACKGROUND

It is oftentimes necessary for an operator of a vehicle to see what is behind the vehicle when operating the vehicle so that the operator does not hit any objects with the vehicle, causing damage to both the object and the vehicle, or to prevent injuring a person who may be in close proximity at the rear of the vehicle. This may be particularly important when backing up the vehicle, for example, down a long driveway or rearwards up or down a ramp when the operator cannot see the rear wheels. Typical interior rear view mirrors provide the operator with some ability to view what is behind the vehicle, however, these rear view mirrors oftentimes do not provide sufficient rear-lateral vision, so if the vehicle is not reversing straight backward, but is angled at all, there is still the fear that the vehicle may hit an object or person situated laterally to the rear of the vehicle in a blind spot or otherwise.

Vehicles such as bobcats or skidsteers are oftentimes lacking any devices for aiding an operator to get a clear view of the rear of the vehicle, so the operator is oftentimes reliant on a person standing outside the vehicle giving directions to the operator of the vehicle as the operator is backing up the vehicle. However, this is inconvenient as a second person is not always readily available to give directions to the operator of the vehicle and such directions may in any case be confusing or otherwise insufficient for the operator to avoid crashing the vehicle. Alternatively, the operator of a vehicle will sometimes stick their head out of the side of the vehicle and crane their neck to view the rear of the vehicle, though this is dangerous as the person's head is outside the vehicle making it a risk that they might hit their head on an object as the vehicle is backing up, such as on a sign or a hanging beam, and it furthermore may cause significant strain on the operator's neck leading to neck injury or soreness. Additionally, as an operator has their head out the side of the vehicle and is looking backward, they will completely lose sight of the front end of the vehicle, making it possible that the front end of the vehicle will damage something while the operator is not paying any attention to it. Devices for aiding in increasing the field of view of the rear of a vehicle are thus important from a safety standpoint.

To aid in viewing the rear of a vehicle, some vehicles have mirrors that are mounted on their exterior. Some vehicle mirrors are bolted and/or welded onto the external surface of the vehicle that allow the vehicle operator to glance over at the reflective surface of the mirror to view objects at the rear of the vehicle reflected therein. However, attaching such mirrors to the vehicle can be time-consuming and difficult. For example, to attach such a mirror to the exterior of farm or construction machinery could involve drilling one or many holes in the machinery, which is both dangerous and can cause permanent damage to the equipment. Bolting or welding such mirror devices to a vehicle can make the mirrors difficult to remove when they are no longer needed or when they are inconvenient. The use of welding to attach a mirror may furthermore damage or weaken the integrity of the vehicle arms or vehicle exterior through the application of high heat. The application and removal of such mirrors mounted in this way can thus require complex equipment such as brackets, glue, and welding equipment, can be time-consuming and complicated, and can result in permanent damage to the vehicle exterior.

### SUMMARY OF THE INVENTION

It would be advantageous to have a simple, cost-effective device that allows for safely viewing the rear of a vehicle without causing damage to the vehicle.

In an aspect, a reflective surface device detachably mountable to the exterior of a vehicle comprises an arm having a proximal end and a distal end, a reflective surface disposed adjacent the distal end of the arm, and a magnet disposed adjacent the proximal end of the arm.

In a further aspect, a method of detachably mounting a reflective surface to a vehicle comprises the steps of providing a reflective surface device comprising an arm having a proximal end and a distal end, a reflective surface disposed adjacent the distal end of the arm, and a magnet disposed adjacent the proximal end of the arm; and positioning the magnet on an exterior surface of the vehicle with the reflective surface facing generally rearward of the vehicle, whereby magnetic forces between the magnet and the exterior surface of the vehicle support the reflective surface device on the vehicle. The reflective surface may be detached from the vehicle by applying a force to overcome the magnetic forces between the magnet and the exterior surface of the vehicle.

In yet a further aspect, a method of manufacturing a reflective surface device comprises the steps of providing an arm having a proximal end and a distal end, providing a reflective surface, providing at least one magnet, attaching the reflective surface adjacent the distal end of the arm, and attaching the at least one magnet adjacent the proximal end of the arm.

The device and methods may allow a user to detachably mount a reflective surface to a vehicle without significantly damaging the vehicle, and which is relatively simple, safe, and convenient to use and manufacture.

### DESCRIPTION OF THE DRAWINGS

While the invention is claimed in the concluding portions hereof, aspects of the invention are provided in the accompanying detailed description which may be best understood in conjunction with the accompanying diagrams where like parts in each of the several diagrams are labeled with like numbers, and where:

FIG. 1 is a front elevation view of a reflective surface assembly in an aspect;

FIG. 2A is a side elevation view of two magnets;

FIG. 2B is a side elevation view of a plate;

FIG. 2C is a front exploded elevation view of a reflective surface, arm, and threaded fastener in an aspect;

FIG. 2D is a front exploded elevation view of a reflective surface assembly in an aspect;

FIG. 3 is a front elevation view of a reflective surface assembly in an aspect detachably mounted to a right side of a vehicle;

FIG. 4 is a perspective view of a reflective surface assembly in an aspect detachably mounted to a left side of a vehicle, the reflective surface assembly being the mirror image of the reflective surface assembly shown in FIG. 3;

FIG. 5 is a side elevation view of the reflective surface assembly and vehicle shown in FIG. 4; and

FIG. 6 is a perspective view of the pair of the reflective surface assemblies shown in FIGS. 3 and 4 detachably mounted to a vehicle.

### DETAILED DESCRIPTION OF THE ILLUSTRATED EMBODIMENTS

A reflective surface assembly detachably mountable to an exterior of a vehicle to improve the visibility and field of view of the rear of the vehicle for a vehicle operator is provided. The reflective surface assembly can allow the vehicle operator to view objects at the rear of the vehicle on a reflected surface of the reflective surface assembly. The assembly can be detachable or quickly releasable from the exterior of the vehicle, and can be re-applied to the same or a different vehicle, as desired, without substantially damaging the vehicle. The reflective surface assembly can fit vehicles of many types or sizes and can be adjustable so as to suit various vehicle and operator heights and to provide for customized angular vantage points of objects at the rear of the vehicle.

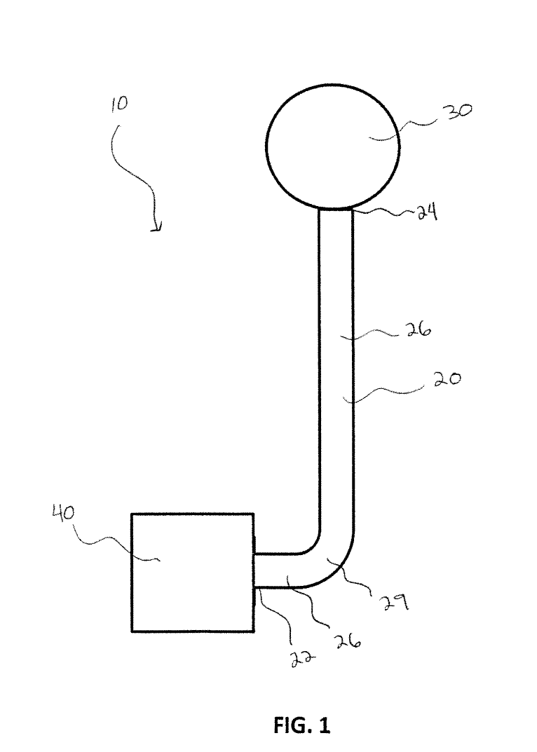

FIG. 1 illustrates a reflective surface assembly 10 in an aspect. The assembly 10 has an arm 20 having a proximal end 22 and a distal end 24. A reflective surface 30 is disposed adjacent the distal end 24 of the arm 20 and a magnet 40 is disposed adjacent the proximal end 22 of the arm 20.

The reflective surface 30 could be any type of surface that produces a reflection of objects to which it faces, such as a mirror, and is disposed adjacent the distal end 24 of the arm 20. The reflective surface 30 may be a plain flat-surface mirror, or could be a convex mirror. The surface area of the reflective surface 30 could vary, depending on the size of the field of view desired. The shape of the reflective surface 30 may vary, as well, and could be rectangular, oval, rhomboid, and in some aspects, could be circular. In an aspect, the reflective surface 30 is a six inch convex circular mirror. The mirror could alternatively be an 8-inch convex circular mirror.

In an aspect, the arm 20 may comprise a first elongate member 26 extending substantially vertically with respect to the ground and a second elongate member 28 extending substantially horizontally with respect to the ground. The first and second elongate members 26, 28 may be connected to one another at an elbow 29. In an aspect, the first and second elongate members 26, 28 are continuous with one another, and the elbow 29 has a curved configuration such that the first elongate member 26 extends generally perpendicularly to the second elongate member 28. In an aspect, the elbow 29 is a 90 degree bend in a continuous arm 20 comprising the first and second elongate members 26, 28.

The arm 20 may be made out of any suitable material capable of supporting the reflective surface 30. In an aspect, the arm 20 is made out of a corrosion-resistant metal, such as aluminum or steel, and in a further aspect, the arm 20 can be a ¾ inch pipe or electrical conduit with a 90 degree bend at the elbow 29. In an alternative aspect, the arm 20 can be made out of plastic or a polymer. The arm 20 could comprise a pipe or a hollow tube, and in a further aspect, the tube can be filled with a vibration-dampening foam so as to minimize vibration of the assembly 10 while the vehicle to which it is attached is in motion. In an aspect, the arm is stiff and inflexible to minimize vibration.

The arm 20 may be of fixed length or may be extendable or adjustable in some aspects. For example, at least one of the first and second elongate members 26, 28 of the arm 20 may comprise telescoping tubular members with at least one member being a channel into which at least one other member slidingly extends. The members could be held in place through the use of a detent mechanism or spring loaded ball bearings and corresponding apertures.

In some aspects the first elongate member 26 is greater in length than the second elongate member 28 to allow the arm 20 to be of sufficient height for the operator of a vehicle to view the reflective surface 30, while still allowing the first elongate member 26 to be long enough to hold the reflective surface 30 out of the way of any moving appendages on the vehicle. In some aspects, the first elongate member 26 may be fixed or extendable to be at least 3 times greater in length than the second elongate member 28.

The elbow 29 may be fixed or adjustable to allow for angular movement of the first elongate member 26 about the elbow 29. A pivot mechanism can be provided at any point along the arm 20, including at the elbow 29, and in an aspect, the first elongate member pivots about the elbow 29 when the arm 20 is subject to a force of at least a predetermined threshold. In an aspect, the pivot mechanism is at the elbow 29 and comprises a pin the connects the first elongate member 26 to the second elongate member 28 and allows the first elongate member 26 to pivot about the elbow 29 or to allow for relative rotation therebetween. A release mechanism can be provided that allows the first elongate member 26 to pivot with respect to the second elongate member 28 about the elbow 29 when a predetermined force is applied to the first elongate member 26. It will be appreciated, however, that the pivot mechanism may be located along any portion of the arm 20, allowing the reflective surface 30 to pivot in relation to the vehicle to which it is detachably mounted.

The reflective surface 30 may be connected to the distal end 24 of the arm 20 through any known means, including the use of at least one bolt to attach the reflective surface 30 directly to the arm 20. In an aspect, the reflective surface 30 may be rotatable by a full 180 degrees with respect to the vertical axis of the arm 20, so as to allow the assembly 10 to be used on either side of the vehicle interchangeably. This functionality may be provided through any known means, including the use of a pipe extending downward from the reflective surface 30 and which fits snugly into a channel formed in the distal end 24 of the first elongate member 26, so as to allow rotational movement of the reflective surface 30 and downwardly-extending pipe about a vertical axis of the first elongate member 26. In another aspect, a swivel stud could be connected to an opposing side of the reflective surface 30 that allows for such movement. The reflective surface 30 may also be adjustable and tiltable about a horizontal axis of the first elongate member 26 to capture different angles. For example, the reflective surface 30 could be connected to the distal end 24 of the arm 20 through the use of a ball and socket joint that allows pivotal angular movement or tilting capabilities of the reflective surface 30 both up and down and side to side. In an alternative aspect, the distal end 24 of the arm 20 may be flattened so as to allow easy attachment of the reflective surface 30 against a face of the flattened distal end 24 of the arm 20.

At least one magnet 40 is disposed adjacent the proximal end 22 of the arm 20, and which can allow for detachably mounting the assembly 10 onto a vehicle having a metallic or magnetically-active portion. It will be understood that the strength and size of the at least one magnet 40 may vary, depending on the amount of force desired to overcome the magnetic force to release the arm 20 from the vehicle and with due consideration given to the weight of the reflective surface 30 and arm 20. In an aspect, the at least one magnet 40 is a 225 pound pull magnet. The at least one magnet 40 could comprise two or more magnets, which may be beneficial for reflective surface assemblies having longer arms, where vibrations of the vehicle to which they are detachably mounted can cause the assembly to pop off the vehicle. In some aspects, the collective pull of the at least one magnet is at least 450 pounds, and in a further aspect, the collective pull of the at least one magnet having a collective pull of 450 pounds comprises two 225 pound pull magnets.

The at least one magnet 40 can be connected to the arm 20 through any known means, including the use of a bolt and washer welded to the arm 20, with the at least one magnet 40 attached thereto with a nut and lockwasher. In alternative aspects, the at least one magnet 40 could be connected to the arm 20 through the use of a heavy glue or the like. In an aspect, the proximal end 22 of the arm 20 extends generally perpendicularly of the at least one magnet 40.

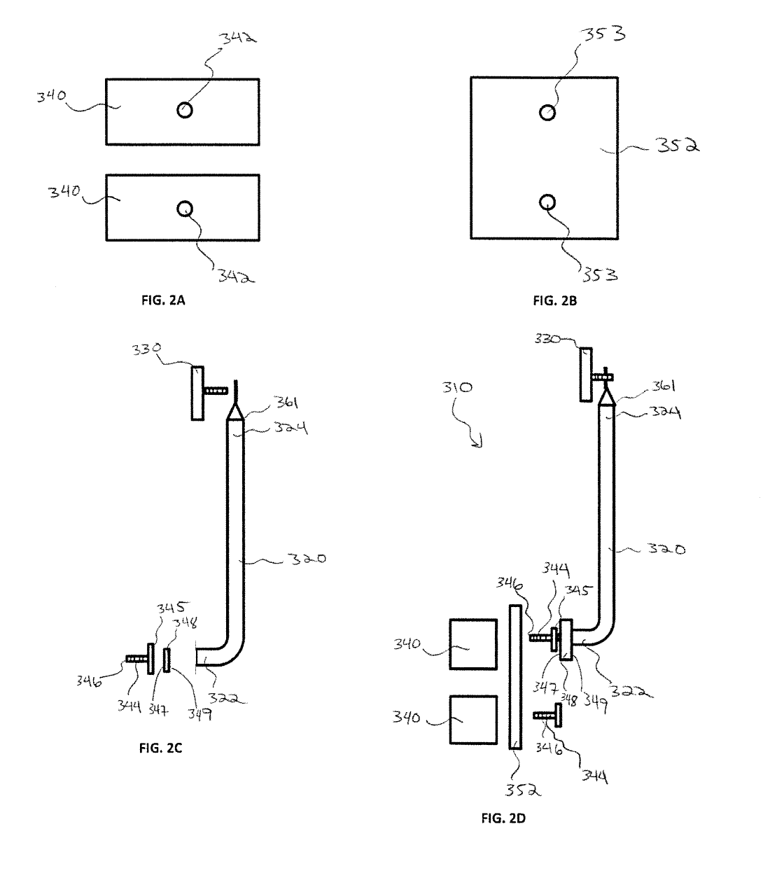

FIGS. 2A to 2D illustrate a method of manufacturing a reflective surface assembly 310 in an aspect. In a method of manufacturing a reflective surface assembly 310, a reflective surface 330 is attached adjacent a distal end 324 of an arm 320. In the aspect shown, the distal end 324 of the arm 320 is flattened so as to allow for easy attachment of the reflective surface 330 thereto. In the aspect shown, the reflective surface 330 may be rotated about a vertical axis of the arm at a rotating joint 361. At least one magnet 340 is attached adjacent a proximal end 322 of the arm 320, and in an aspect, the proximal end 322 of the arm 320 extends generally perpendicularly of the at least one magnet 340.

The at least one magnet 340 can have at least one internal thread 342 disposed therein. In FIGS. 2A to 2D, the at least one magnet comprises two separate magnets 340, each with one internal thread 342, though in some aspects there may only be one magnet or there may be more than two magnets, and in some aspects, each magnet may have more than one internal thread.

An arm-securing externally threaded fastener 344 can be provided that has a head portion 345 and an external thread portion 346 mateable with at least one internal thread 342 of the at least one magnet 340. The head portion 345 of the arm-securing externally threaded fastener 344 can be secured adjacent the proximal end 322 of the arm 320. The external thread portion 346 of the arm-securing externally threaded fastener 344 can be mated with at least one of the at least one internal thread 342 to securely connect the at least one magnet 340 to arm 320. The head portion 345 of the arm-securing externally threaded fastener 344 can be attached adjacent the proximal end 322 of the arm 320 through many known means, such as by welding a first side 347 of a washer 348 to the head portion 345 of the arm-securing externally threaded fastener 344 and welding a second side 349 of the washer 348 adjacent the proximal end 322 of the arm 320.

A plate 352 can be provided that comprises a plurality of threaded fastener-receiving apertures 353. The plate 352 could be made out of any suitable material, including metals or plastics, and in an aspect, the plate 352 comprises a ⅛ inch thick steel plate.

In some aspects, the external thread portion 346 of the arm-securing externally threaded fastener 344 can be received in one of the threaded fastener-receiving apertures 353 prior to mating the external thread portion 346 of the arm-securing externally threaded fastener 344 with a first internal thread of the at least one internal thread 342. An external thread portion 346 of a second externally threaded fastener 344 can be received in one of the threaded fastener-receiving apertures 353 and the external thread portion 346 of the second externally threaded fastener 344 can be mated with a second internal thread of the at least one internal thread 342. The first internal thread and the second internal thread 342 could be disposed on the same or different magnets 340.

In operation, a vehicle operator may detachably mount a reflective surface assembly on a vehicle, such that the operator can see the reflection of objects in the reflective surface of the assembly while inside the vehicle.

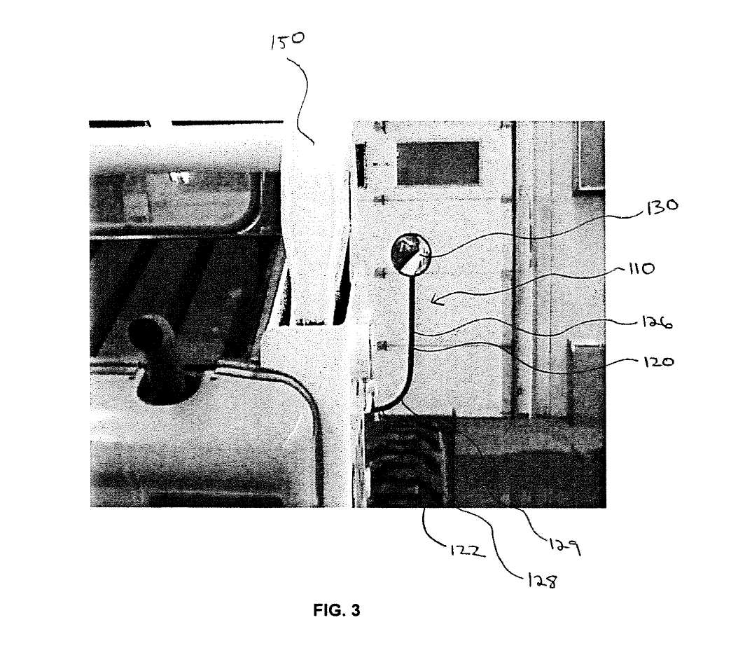

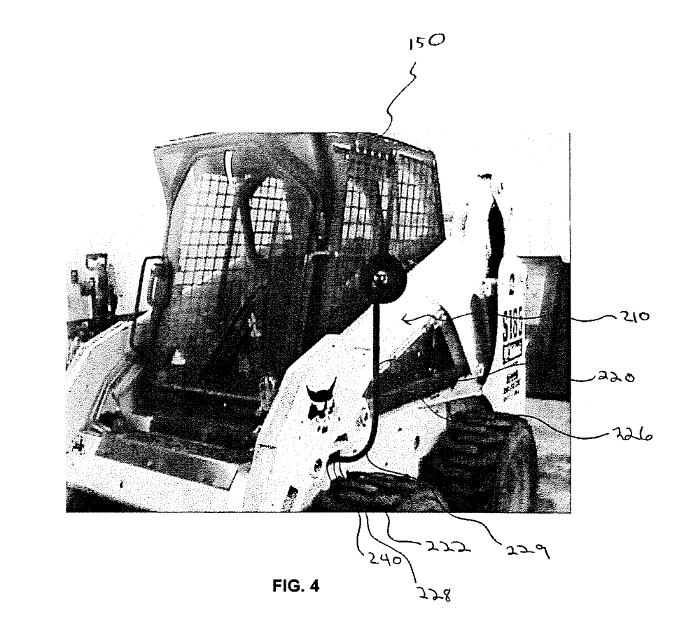

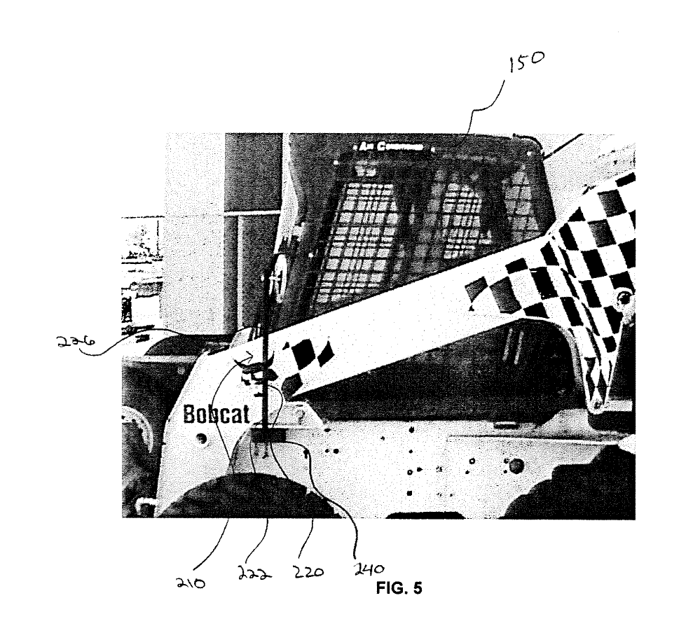

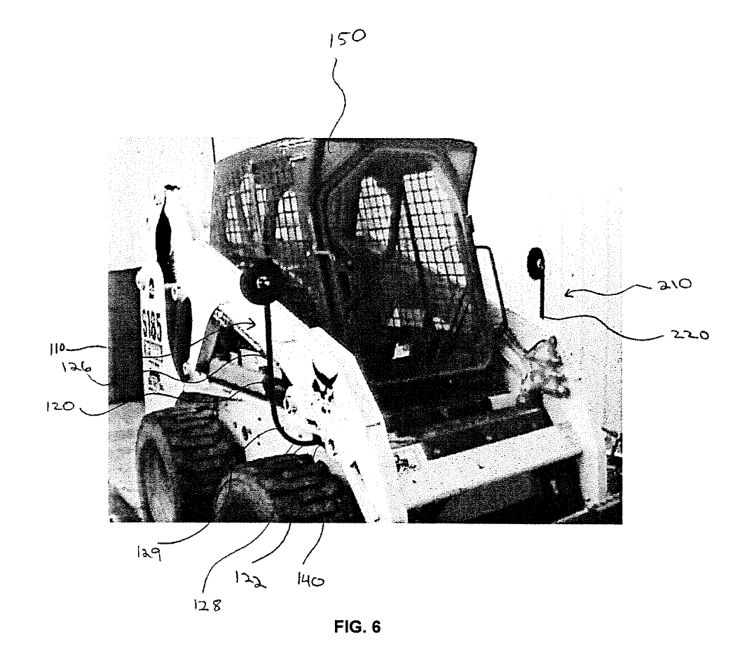

As is shown in FIGS. 3 to 6, a reflective surface assembly 110 may be detachably mounted to a right side of a vehicle 150 so that a reflective surface 130 generally faces toward the rear of the vehicle 150. A reflective surface assembly 210, which may be a mirror image of the reflective surface assembly 110, may be detachably mounted to a left side of the vehicle 150 so that a reflective surface 230 generally faces toward the rear of the vehicle 150. In some aspects the reflective surface assemblies 110, 210 may be identical, with the reflective surface 130 being rotatable at least 180 degrees about a vertical axis of an arm 120 or 220, such that the reflective surface assemblies 110, 210 can be interchangeably mounted on either side of the vehicle 150 with the reflective surface 130 facing generally rearward of the vehicle 150. It will also be understood that one assembly 110 or 210 may be used at a given time, or both assemblies 110 and 210 may be used at the same time as a pair, depending on the requirements of the vehicle operator.

At least one magnet 140, 240 disposed adjacent a proximal end 122, 222 of the arm 120, 220 can releasably attach to the skidsteer or other vehicle 150 to allow the reflective surface assemblies 110, 210 to be detachably mounted to the vehicle 150. While the figures show the reflective surface assemblies 110, 210 detachably mounted to a skidsteer, it will be understood that the assemblies 110, 210 could also be used on other vehicles of varying types and sizes, such as tractors and trucks or any other vehicle having a magnetically active or metallic portion capable of engaging the at least one magnet 140, 240. The at least one magnet 140, 240 can mate with any metallic portion of the vehicle 150, for example, the external operator or passenger side of the vehicle 150. For example, in an aspect, the assembly 110, 210 is detachably mounted to the arms of a skidsteer. In a further aspect, the assembly 110, 210 is detachably mounted to a vehicle door. The at least one magnet 140, 240 can mate with and engage the corresponding metallic portion of the vehicle 150 to releasably secure the arm 120, 220 to the vehicle 150 due to the magnetic attractive forces therebetween.

The reflective surface assembly 110, 210 may be positioned at any convenient location on the vehicle 150, and in an aspect it can be detachably mounted to a side of the vehicle 150, and more particularly, may be detachably mounted on the anterior lateral external section of the vehicle 150 so as to allow a vehicle operator to easily view what is behind the vehicle 150 while remaining in the vehicle 150 behind the steering wheel. This may be particularly useful when the operator is reversing the vehicle 150 and needs to know the position of objects behind the vehicle 150.

As indicated above, the reflective surfaces 130 can generally face toward the rear of the vehicle 150. The reflective surface 130 can be detachably supported on the external of the vehicle 150 by the arm 120, 220 and at least one magnet 140, 240. An elbow 129, 229 can allow the arm 120, 220 to extend generally upward and outward with respect to the ground and the vehicle 150 to which it may be detachably mounted. The arm 120, 220 can extend along a second elongate member 128, 228 outward from the vehicle 150, and can extend upwardly from the elbow 129, 229 along the first elongate member 126, 226. The assemblies 110, 210 in this way can protrude outwardly and upwardly from the sides of the vehicle 150 to provide the operator with an increased field of view of potential blind spots on the rear or side of the vehicle 150.

The placing of the at least one magnet 140, 240 on the vehicle 150 may vary, depending on considerations such as the type of vehicle 150, the height of the operator's seat, and the height of the operator so as to allow the operator to view objects in the rear field of view of the vehicle 150, with minimal head movement. The operator may adjust the position of the reflective mirror assembly 110, 210 so as to allow for adequate reflection from the reflective surface 130. For example, for an operator seated lower in a vehicle 150, the at least one magnet 140, 240 and thus the entire assembly 110, 210 may be positioned lower on the vehicle 150 than for an operator that is seated higher in the vehicle 150. The assembly 110, 210 may be detachably mounted to the operator or passenger sides of the vehicle 150 and as the at least one magnet 140, 240 provides for releasable engagement with the vehicle 150 with no significant permanent damage to the vehicle 150, the assembly 110, 210 may be used by successive vehicle operators and on a plurality of different vehicles, accommodating different operator heights of different operators of the same or different vehicles.

Similar to the assembly 10 described above, the assemblies 110, 210 could have reflective surfaces 130 that are pivotable with respect to the arm 120, 220 and may be pivotable from side to side and/or up and down to provide optimum angular views of the rear of the vehicle 150 for the operator. The reflective surface 130 can be pivotally connected to the first elongate member 126, 226 and may be angularly adjustable with respect thereto to allow for adjustable positioning of the reflective surface 130 upward, downward, rotationally, or laterally so as to allow the operator to obtain the best possible view of the rear of the vehicle 150 in the reflected image of the reflective surface 130. Similarly, the arms 120, 220 may be adjustable in some aspects to provide increased lateral length or increased vertical height.

By strategically placing the assembly 110, 210 on the vehicle 150, and making necessary adjustments to the assembly 100, 210, as applicable, an operator may easily view the reflective surface 130 of the assembly 110, 210 from inside the vehicle 150. An operator may view objects positioned lateral to the operator's or passenger's side rear quarter panel of the rear portion of the vehicle 150 by looking at a reflection of the objects reflected on the reflective surface 130, 230 of the assembly 110, 210 without turning completely around. In this way, the operator may be allowed to maneuver the vehicle 150 so as to avoid crashing into objects situated rearward of the vehicle 150 or to correctly guide the vehicle 150 to where the operator desires it to go.

To release the assembly 110, 210 from the vehicle 150 when the assembly 110, 210 is no longer required, a force may be applied to the assembly 110, 210 which overcomes the magnetic attraction between the at least one magnet 140, 240 and the vehicle 150, allowing the at least one magnet 140, 240 to separate from the vehicle 150. In this way, the assembly 110, 210 is quickly releasable from the vehicle 150 without causing significant or permanent damage to the vehicle 150. The assembly 110, 210 may then be stowed away for subsequent use on the same or different vehicles.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A reflective surface device detachably mountable to the exterior of a vehicle comprising:
an arm having a proximal end and a distal end;
a reflective surface disposed adjacent the distal end of the arm; and
at least one magnet disposed adjacent the proximal end of the arm.

2. The device of claim 1 wherein the arm comprises a first elongate member extending generally perpendicularly to a second elongate member.

3. The device of claim 2 wherein the first elongate member is at least 3 times greater in length than the second elongate member.

4. The device of claim 1 wherein the proximal end of the arm extends generally perpendicularly from the at least one magnet.

5. The device of claim 1 wherein the reflective surface is rotatable 180 degrees about the vertical axis of the arm, whereby the device is interchangeably mountable between a first side of the vehicle and a second side of the vehicle with the reflective surface facing generally rearward of the vehicle.

6. The device of claim 1 wherein the at least one magnet comprises at least one magnet providing a magnetic pull of substantially 225 pounds.

7. The device of claim 1 wherein the collective pull of the at least one magnet is at least 450 pounds.

8. A method of detachably mounting a reflective surface to a vehicle comprising the steps of:
providing a reflective surface device comprising:
an arm having a proximal end and a distal end;
a reflective surface disposed adjacent the distal end of the arm; and
at least one magnet disposed adjacent the proximal end of the arm; and
positioning the at least one magnet on an exterior surface of the vehicle with the reflective surface facing generally rearward of the vehicle, whereby magnetic forces between the at least one magnet and the exterior surface of the vehicle support the reflective surface device on the vehicle.

9. The method of claim 8 further comprising the step of detachably mounting a second reflective surface to an opposite side of the vehicle.

10. The method of claim 8 wherein the vehicle is a skidsteer.

11. The method of claim 10 wherein the at least one magnet is positioned on an arm of the skidsteer.

12. The method of claim 8 further comprising the step of rotating the reflective surface about a vertical axis of the arm.

13. The method of claim 12 further comprising the step of rotating the reflective surface 180 degrees about the vertical axis of the arm.

14. The method of claim 8 further comprising the step of tilting the reflective surface relative to the arm.

15. The method of claim 8 further comprising the step of extending at least a portion of the arm.

16. A method of manufacturing a reflective surface device comprising the steps of:
providing an arm having a proximal end and a distal end;
providing a reflective surface;
providing at least one magnet;
attaching the reflective surface adjacent the distal end of the arm; and
attaching the at least one magnet adjacent the proximal end of the arm.

17. The method of claim 16 wherein the at least one magnet comprises at least one internal thread and wherein the step of attaching the at least one magnet adjacent the proximal end of the arm further comprises the steps of:
providing an arm-securing externally threaded fastener comprising:
a head portion; and
an external thread portion mateable with at least one internal thread of the at least one magnet;
securing the head portion of the arm-securing externally threaded fastener adjacent the proximal end of the arm; and
mating the external thread portion of the arm-securing externally threaded fastener with a first internal thread of the at least one internal thread.

18. The method of claim 17 wherein the step of securing the head portion of the arm-securing externally threaded fastener adjacent the proximal end of the arm further comprises the steps of:
welding a first side of a washer to the head portion of the arm-securing externally threaded fastener; and
welding a second side of the washer adjacent the proximal end of the arm.

19. The method of claim 17 further comprising the steps of:
providing a plate comprising a plurality of threaded fastener-receiving apertures;
receiving the external thread portion of the arm-securing externally threaded fastener in one of the threaded fastener-receiving apertures prior to the step of mating the external thread portion of the arm-securing externally threaded fastener with the first internal thread of the at least one internal thread;
receiving an external thread portion of a second externally threaded fastener in one of the threaded fastener-receiving apertures; and
mating the external thread portion of the second externally threaded fastener with a second internal thread of the at least one internal thread.

20. The method of claim 19 wherein the first internal thread and the second internal thread are disposed on separate magnets.
